(19) United States
(12) Patent Application Publication
(10) Pub. No.: US 2016/0014978 A1
(43) Pub. Date: Jan. 21, 2016

(54) Weed Inhibitor and Design Template

(71) Applicant: Ahmad Alshalabi, Valparaiso, IN (US)

(72) Inventor: Ahmad Alshalabi, Valparaiso, IN (US)

(21) Appl. No.: 14/336,249

(22) Filed: Jul. 21, 2014

(51) Int. Cl. A01G 9/02; A01C 14/00

(52) U.S. Cl. CPC A01G 9/028; A01C 14/00

(57) ABSTRACT

A floral design template that is operable to guide a user in the creation of a design using flowers and wherein the design template is operable to further inhibit weeds from growing therethrough. The floral design template includes a body manufactured from a non-porous material having a plurality of apertures journaled therethrough. The body includes on the upper surface thereof a plurality of design areas. The design areas provide indication of the type and/or color of flower to plant therein so as to create the desired floral ornamental arrangement.

### FIELD OF THE INVENTION

The present invention relates generally to gardening accessories, more specifically but not by way of limitation, a substrate that is operable to inhibit weed growth in the area in which the substrate is superposed and further is operable to provide apertures for planting flowers or plants wherein the apertures provide the correct spacing for the mature plant and/or serve as a template for a ornamental design.

### BACKGROUND

Gardening is an activity in which millions of individuals participate in on a regular basis. Gardening can range from minor projects such as taking care of plant life in a windowsill to more complex home gardens and/or flowerbeds that require more regular maintenance from the owner. Regardless of the size and scope of the garden and/or flowerbed, there are core responsibilities and task required when caring for a garden and/or flowerbed. Initially, the soil must be prepared with desirable topsoil. This can be either cultivated by tilling the ground or can be added to the existing ground so as to provide the appropriate soil type for the plants/flowers that will be planted.

One issue with flowerbeds and gardens are weeds. Regardless of the size garden and/or flowerbed it is inevitable that weed control will be required. Typically, a caretaker will allocate a certain amount of time at regular intervals and physically pull the weeds from the area. This can be very time consuming and tedious for the caretaker. While weed blockers are available, they have proven to be ineffective for addressing the other features of the present invention described herein.

During the initial phase of planting a garden and/or flowerbed it is important to space the young plants at the proper intervals so once the plants are mature that the required space between each plant is achieved. Currently no existing technology provides this functionality with all of the plant species commercially available. Additionally, it is desirable for a homeowner to plant flowers and/or plants in a design so subsequent the growth of the plant the collective appearance of the plants forms a design such as but not limited to a flag or other shape such as a heart.

Accordingly, there is a need for weed inhibitor and a design template that substantially inhibits weeds from growing in an area and further assists the user in either the proper spacing of plants or provides a design template for the plants.

### SUMMARY OF THE INVENTION

It is the object of the present invention to provide a weed inhibitor and design template that is operable to inhibit weed growth in an area in which the device has been superposed.

Another object of the present invention is to provide a weed inhibitor and design template that is planar in manner and manufactured from a flexible non-porous material such as but not limited to rubber.

A further object of the present invention is to provide a weed inhibitor and design template that includes a plurality of apertures that provide the proper spacing intermediate each plant.

An additional object of the present invention is to provide a weed inhibitor and design template that substantially inhibits weed growth wherein the apertures are further arranged in a pattern so as to form a guideline for planting young plants wherein the mature plants will be presented in an ornamental pattern such as but not limited to a heart or a flag.

Still a further object of the present invention is to provide a weed inhibitor and design template that is planar in manner wherein the top surface of the device includes either indicia and/or colors to mark what species of plant should be planted in a specific aperture in order to create the intended design.

Another object of the present invention is to provide a weed inhibitor and design template that is lightweight and easy to use.

To the accomplishment the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention disposed in an exemplary flower box; and

FIG. 2 is a top view of an embodiment of the present invention illustrating an exemplary design; and

FIG. 3 is a flow chart of the utilization process of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a weed inhibitor and design template 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

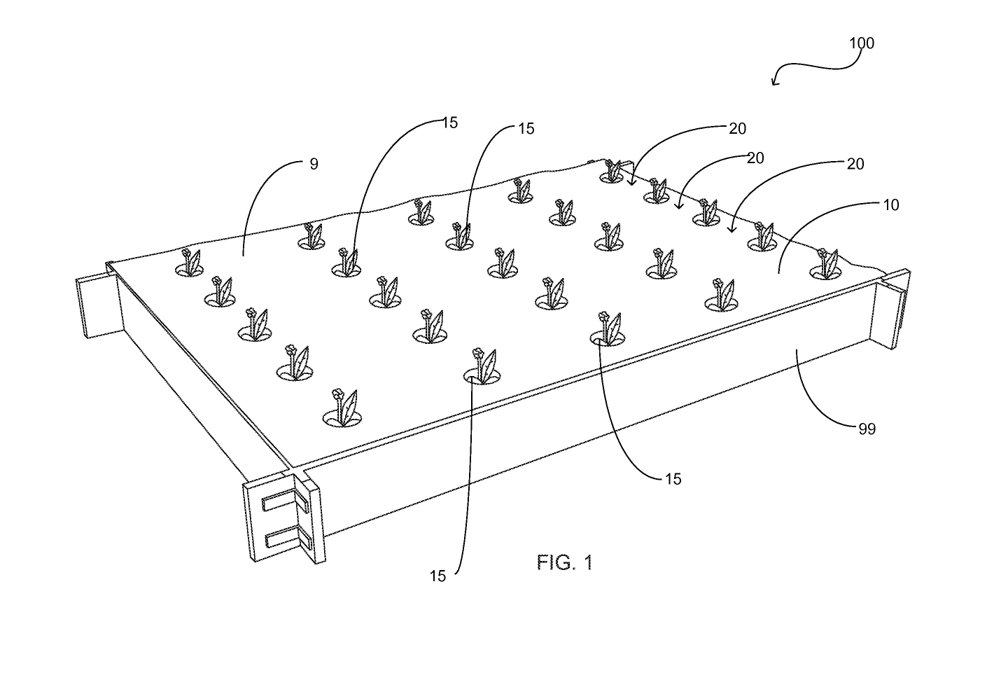

Illustrated in particular in FIG. 1 herein, the weed inhibitor and design template 100 further includes a body 10 that is rectangular in shape. The body 10 is substantially planar in manner and manufactured from a flexible material such as but not limited to rubber having an upper surface 9 and a lower surface (not illustrated herein). The body 10 of the weed inhibitor and design template 100 is operable to inhibit weeds from propagating therethrough. In the preferred embodiment, the body 10 is non-porous so as to inhibit passage of weeds or other undesired vegetation to penetrate therethrough. While the shape of the embodiment in FIG. 1 is rectangular in shape, that shape has been created to accommodate the exemplary flower box 99. It is contemplated within the scope of the present invention that the body 10 could be cut to be any shape and size desired by a user. Those skilled in the art will recognize that the body 10 could be formed in numerous different shapes and sizes. Additionally, it is further contemplated within the scope of the present invention that the body 10 could be manufactured from numerous different types of non-porous materials. Existing weed blocking material is porous so as to allow water therethrough but this design is flawed as the material begins to erode and is ultimately penetrated by weeds and other vegetation.

Still referring to FIG. 1 the body 10 includes a plurality of plant apertures 15 journaled therethrough. The plant apertures 15 are annular in shape and function to provide an area for a desired vegetation, such as but not limited to flowers, to be planted in the soil underneath and aligned with the plant apertures 15. The plant apertures 15 are manufactured to have a sufficient diameter so as to accommodate the bottom portion of the full grown planted therein. While no particular size is required, good results have been achieved utilizing a plant aperture 15 that is approximately two inches in diameter. The plant apertures 15 are spaced on the weed inhibitor and design template 100 so as to provide the correct spacing required intermediate each plant once they are full-grown. The spacing 20 intermediate each plant aperture is dependent on the type of plant that will be planted in the plant apertures 15. It is contemplated within the scope of the present invention that the body 10 will be provided with different amounts of plant apertures 15 having different spacing so as to provide the correct spacing for the vegetation that will be planted. While the embodiment illustrated in FIG. 1 herein, illustrates a certain number of plant apertures 15 and spacing 20, it is contemplated that the body 10 could have any number of plant apertures 15 and that the spacing 20 intermediate therebetween could vary.

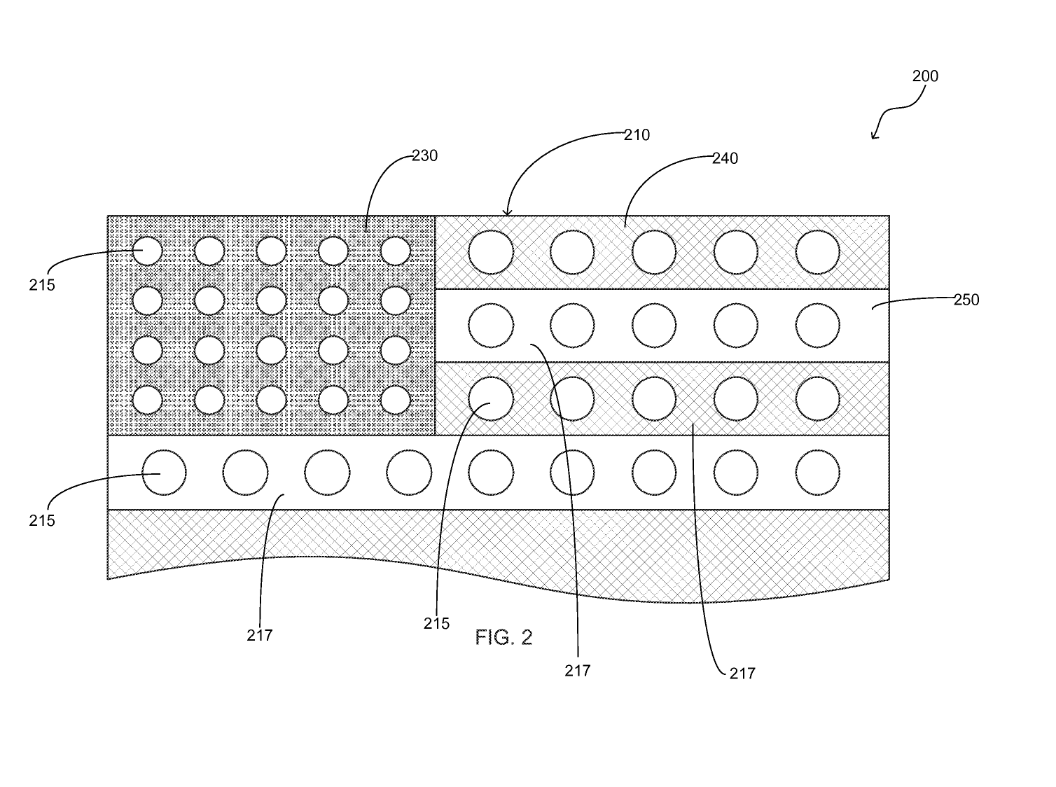

Referring in particular to FIG. 2 herein, an alternative embodiment of the weed inhibitor and design template 200 is illustrated therein. A body 210 is provided and is constructed similarly to body 10. The body 210 has distinct design areas imprinted thereon. A first design area 250 functions to indicate the type and color of vegetation that should be planted in the plant apertures 215 located within the first design area 230. In the exemplary embodiment illustrated herein, the first design area 230 is provided with either indicia and/or color so as to guide a user as to what type and more specifically what color to plant in the plant apertures 215 in the first design area 230. It is contemplated within the scope of the present invention that the first design area 230 could utilize numerous techniques to guide a user as to what type and color of vegetation should be planted therein. A second design area 240 and a third design area 250 are provided on the body 210. The second design area 240 and third design area 250 function similarly to the first design area 230 wherein each is operable to dictate to a user the color and type of vegetation that should be planted therein. The plant apertures 215 and spacing 217 function to create a specific overall ornamental design to be visually presented by the vegetation planted within the weed inhibitor and design template 200. By way of example but not by way of limitation, the embodiment illustrated in FIG. 2 herein provides a first design area 230, second design area 240 and third design area 250 that function to create an ornamental vegetation display that represents the American flag. While this exemplary embodiment has been illustrated herein, it is contemplated within the scope of the present invention that the body 210 could be constructed with as few as one design area or more than three to create a specific shape and/or color of ornamental vegetation display.

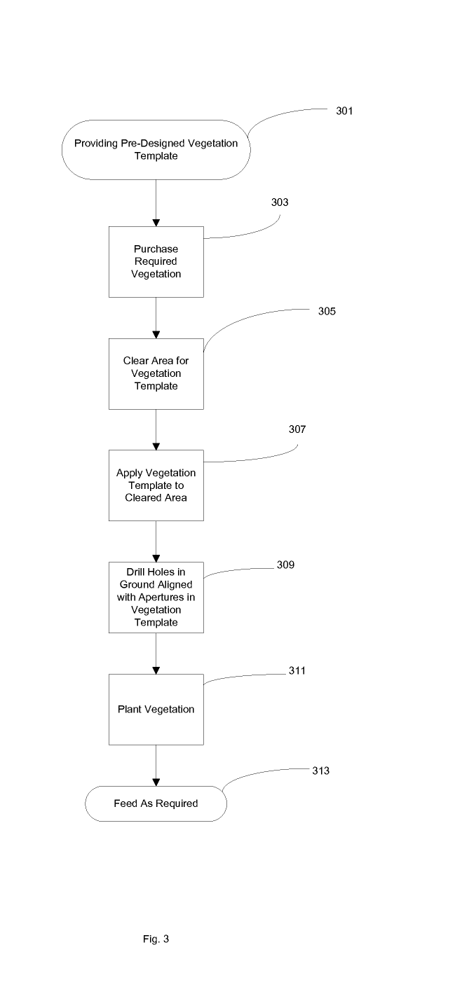

Referring in particular to FIG. 3 herein, a method of use of the weed inhibitor and design template 100 includes the steps listed herein. In step 301, a pre-designed vegetation template is provided to a user. The pre-designed template serves as a guideline to provide an ornamental appearance of vegetation once planted therein. Step 303, a user will purchase the vegetation required to provide the vegetation ornamental design suggested by the weed inhibitor and design template 100. In step 305, a user will clear the desired area in which they wish to superpose the weed inhibitor and design template 100. This clearing is executed by conventional techniques and functions to prepare the soil for planting. Step 307, the user will superpose the weed inhibitor and design template 100 over the prepared area from step 305. In step 309, the user will create holes in the soil where each plant aperture 15 is located in order to prepare the area to receive a plant. Those skilled in the art will recognize that this can be accomplished using numerous techniques. Step 311, the user will plant the required vegetation in each design area as indicated by the weed inhibitor and design template. In step 313, the user will provide the required feeding of the vegetation planted in step 311 whereupon the growth and maturity of the plants will provide a specific ornamental design.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus operable to provide a guideline to create a vegetation ornamental design and inhibit weeds comprising:
a body, said body being planar in manner, said body being manufactured from a non-porous material, said body being flexible;
a plurality of apertures, said plurality of apertures being journaled through said body, said plurality of apertures having spacing intermediate thereto, said plurality of apertures arranged to create an intended design; and
at least one design area, said at least one design area being on said body, wherein at least one design area operable to guide a user in creating an ornamental design with vegetation planted within said plurality of apertures.

2. The apparatus as recited in claim 1, wherein said plurality of apertures are annular in shape.

3. The apparatus as recited in claim 2, wherein said plurality of apertures are approximately two inches in diameter.

4. The apparatus as recited in claim 3, wherein said at least one design area indicates the color of vegetation that should be planted within said at least one design area.

5. The apparatus as recited in claim 4, wherein said at least one design area indicates the type of vegetation that should be planted therein.

6. A weed inhibitor and design template for vegetation that is operable to assist a user in creating an ornamental design with flowers comprising:
a body, said body being planar in manner, said body having an upper surface and a lower surface, said body being manufactured from a non-porous material, said body being flexible, said body being superposed an area of ground whereupon a user desires to plant vegetation;
a plurality of apertures, said plurality of apertures being journaled through said body, said plurality of apertures being arranged in a specific pattern in order to assist in the creation of a ornamental design, said plurality of apertures having spacing intermediate thereto, said spacing operable to provide sufficient area for mature vegetation;
three design areas, said three design areas being located on the upper surface of said body, said three design areas operable to guide a user in planting vegetation so as to facilitate the creation of an ornamental design.

7. The weed inhibitor and design template as recited in claim 6, wherein said three design areas indicate a different color of vegetation to be planted therein.

8. The weed inhibitor and design template as recited in claim 7, wherein said plurality of apertures are annular in shape.

9. The weed inhibitor and design template as recited in claim 8, wherein said plurality of apertures are approximately two inches in diameter.

10. The weed inhibitor and design template as recited in claim 9, wherein two of said three design areas are oriented in a alternating parallel configuration.

11. The weed inhibitor and design template as recited in claim 10, wherein said three design areas are operable to facilitate a floral ornamental design of the American flag.

12. A method for creating a floral ornamental design using a plurality of different types and colors of flowers comprising the steps of:
providing a pre-designed vegetation template, wherein the vegetation template includes a body that is planar in manner, said body further including a plurality of apertures, said body having thereon a plurality of design areas, said plurality of design areas indicating a color of flowers to be planted therein;
purchasing the required vegetation for said pre-designed vegetation template;
clearing an area, said clearing an area entailing preparing an area of soil for planting of flowers;
applying the pre-designed vegetation template, said pre-designed vegetation template being superposed the area of soil;
drilling holes, said drilling holes consisting of removing a portion of the soil aligned with each of said plurality of apertures in order to receive a flower bulb;
planting vegetation, wherein a user will plant the indicated flowers within the plurality of design areas; and
feeding the vegetation.

13. The method of creating the floral ornamental design as recited in claim 12, wherein said plurality of apertures are annular in shape.

14. The method of creating the floral ornamental design as recited in claim 13, wherein the body further includes spacing intermediate said plurality of apertures, said spacing operable to provide the correct amount of space for the flowers planted within each of said plurality of apertures.

15. The method of creating the floral ornamental design as recited in claim 14, wherein said plurality of apertures are approximately two inches in diameter.

16. The method of creating the floral ornamental design as recited in claim 15, wherein said plurality of design areas are operable to guide a user in planting the correct flowers so as to create a floral arrangement that resembles the American flag.
